(19) United States
(12) Patent Application Publication
(10) Pub. No.: US 2011/0029338 A1
(43) Pub. Date: Feb. 3, 2011

(54) SYSTEM AND METHOD FOR GENERATING A VALUATION OF ONLINE USERS AND WEBSITES FROM USER ACTIVITIES

(75) Inventors: Anurag Kumar, Bangalore (IN); Akhilesh Suresh Shirbhate, Wardha (IN)

Correspondence Address: Michael Buchenhorner P.A., 8540 SW 83 Street, Miami, FL, 33143, US

(73) Assignee: Yahoo! Inc., Sunnyvale, CA (US)

(21) Appl. No.: 12/512,981

(22) Filed: Jul. 30, 2009

(51) Int. Cl. G06Q 10/00

(52) U.S. Cl. 705/7

(57) ABSTRACT

An improved system and method for generating a valuation of online users and websites is provided. The revenue and cost for a user's activities on a website may be calculated for a time period. To calculate the revenue and cost for activities of a user on a website, values for each type of activities of a user on website may be accumulated and input into a function with the value of a revenue type or cost type associated with activities of users on the website. The monetary value of an online user for a website may be calculated as the difference of the revenue for a user and the cost for a user on the website. And the monetary value of a user for a website may be used to generate a valuation of the online user and a valuation of the website.

### FIELD OF THE INVENTION

The invention relates generally to computer systems, and more particularly to an improved system and method for generating a valuation of online users and websites from user activities.

### BACKGROUND OF THE INVENTION

Monetization of websites continues to develop in order to support the growth of new and existing services provided on the Internet. Online services initially introduced subscription fees to generate revenue to support online services. Monetization models have since evolved to replace subscription fees with advertising revenue for many basic services now offered for free. Currently, combinations of monetization models exist on many online services and websites.

Unfortunately, current valuation methods of online users or websites capture limited information of monetization. Metrics for each monetization model were generally developed for charging and collecting revenues for each individual monetization model. For instance, click through rate and advertisement views provide metrics of online advertising revenue. Also, subscriber counts may provide a metric for paid subscription services. However, click through rate does not take into account the value of the click, whether the click generated $1 or $20. Similarly, metrics for advertisement views do not take into consideration the value of cost per million (CPM) impressions generated by an advertisement server. Furthermore, none of the existing metrics takes into consideration shopping clicks, subscription fees, actual revenues and costs consolidation from accounting systems.

What is needed is a way to better capture the valuation of a user who may contribute to revenue through various monetization models.

### SUMMARY OF THE INVENTION

Briefly, the present invention may provide a system and method for generating a valuation of online users and websites. In various embodiments, a user activity log processor executing on a server may extract activities of online users on URLs (Uniform Resource Locator) of web pages in a user activity log. A database engine executing on the database server operably coupled to the user activity log processor executing on the server may include functionality for storing and retrieving data of user activities on websites and financial data for websites. In an embodiment, a data cube with a dimension of user identifiers, a dimension of website property identifiers, and a dimension of activity type identifiers may store a value of an activity type of an activity of a user on a website. The database engine may execute a query function that generates a monetary valuation of an online user for activities by the online user on the website.

To generate a monetary valuation of an online user for activities by the online user on a website, the revenue for a user's activities on a website may be calculated for a time period. Additionally, the cost for a user's activities on a website may be calculated for a time period. To calculate the revenue and cost for activities of a user on a website, in an embodiment, values for each type of activities of a user on website may be accumulated and input into a function with the value of a revenue type or cost type associated with activities of users on the website. The monetary value of an online user for a website may be calculated as the difference of the revenue for a user and the cost for a user on the website. And the monetary value of a user for a website may be output, such as storing the monetary value by user identifier in a database.

Advantageously, the present invention may estimate the lifetime value of an online user for a website using the monetary value of the online user on the website for each of multiple time periods. Furthermore, the present invention may also estimate the valuation of a website using the monetary values of the online users on the website. The present invention may also be used to improve monetization of online users by identifying segments or cluster of users based on their activity profiles and their monetary values for targeting campaigns to increase revenue from segments of online users. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for generating a valuation of online users and websites from user activities, in accordance with an aspect of the present invention;

FIG. 3 is a flowchart generally representing the steps undertaken in one embodiment for generating a valuation of online users, in accordance with an aspect of the present invention;

FIG. 4 is a flowchart generally representing the steps undertaken in one embodiment for calculating the revenue for activities of a user on a website for a time period, in accordance with an aspect of the present invention;

FIG. 5 is a flowchart generally representing the steps undertaken in one embodiment for calculating the cost for activities of a user on a website for a time period, in accordance with an aspect of the present invention; and

FIG. 6 is a flowchart generally representing the steps undertaken in one embodiment for generating a valuation of a website, in accordance with an aspect of the present invention.

### DETAILED DESCRIPTION

### Exemplary Operating Environment

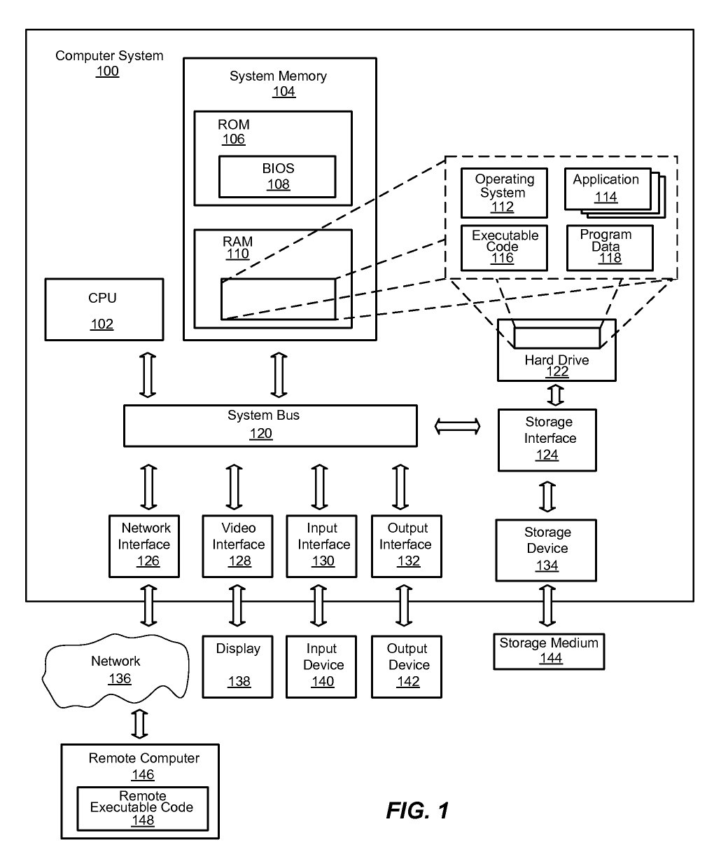

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

Generating a Valuation of Online Users and Websites from User Activities

The present invention is generally directed towards a system and method for generating a valuation of online users and websites from user activities, including but not limited to advertisement views, sponsored ad click, banner ad clicks, page views, services/subscription or good purchased. As used herein, a website means a collection of related web pages, typically interconnected from a home page. The revenue for a user's activities on a website may be calculated for a time period, and the cost for the user's activities on the website may be calculated for the time period. In an embodiment, values for each type of activities of a user on website may be accumulated and input into a function with the value of a revenue type or cost type associated with activities of users on the website. The monetary value of an online user for a website may be calculated as the difference of the revenue for a user and the cost for a user on the website. And the monetary value of a user for a website may be output, such as storing the monetary value by user identifier in a database.

As will be seen, the present invention may support many applications for generating a monetary valuation of online activities. For example, the lifetime value of an online user for a website may be estimated using the monetary value of the online user on the website for each of multiple time periods. Furthermore, the valuation of a website may be estimated using the monetary values of the online users on the website. As will be understood, the various block diagrams, flow charts and scenarios described herein are only examples, and there are many other scenarios to which the present invention will apply.

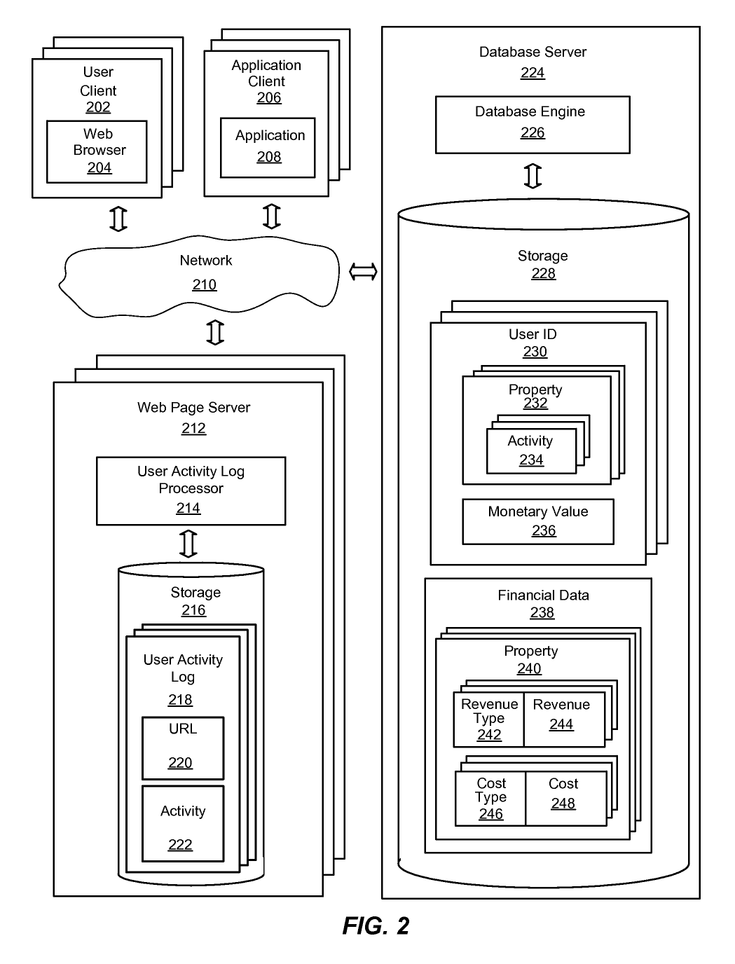

Turning to FIG. 2 of the drawings, there is shown a block diagram generally representing an exemplary architecture of system components for generating a valuation of online users and websites from user activities. Those skilled in the art will appreciate that the functionality implemented within the blocks illustrated in the diagram may be implemented as separate components or the functionality of several or all of the blocks may be implemented within a single component. For example, the functionality for the user activity log processor 214 may be included in the same component as the database engine 226. Or the functionality of the user activity log processor 214 may be implemented as a separate component from the database engine 226 as shown. Moreover, those skilled in the art will appreciate that the functionality implemented within the blocks illustrated in the diagram may be executed on a single computer or distributed across a plurality of computers for execution.

In various embodiments, one or more user client computers 202 may be operably coupled to one or more web page servers 212 by a network 210. The user client computer 202 may be a computer such as computer system 100 of FIG. 1. The network 210 may be any type of network such as a local area network (LAN), a wide area network (WAN), or other type of network. A web browser 204 may execute on the user client computer 202 and may include functionality for receiving a request to retrieve a web page and functionality for sending the request to a web page server to retrieve the requested web page. In general, the web browser 204 may be any type of interpreted or executable software code such as a kernel component, an application program, a script, a linked library, an object with methods, and so forth. The web browser may alternatively be a processing device such as an integrated circuit or logic circuitry that executes instructions represented as microcode, firmware, program code or other executable instructions that may be stored on a computer-readable storage medium.

The web page server 212 may be any type of computer system or computing device such as computer system 100 of FIG. 1. In general, the web page server 212 may provide services for processing a request to retrieve a web page and serve the web page to a user client 202. In particular, the web page server 212 may include a user activity log processor 214 for extracting user activities on URLs (Uniform Resource Locator) of web pages in a user activity log. The user activity log processor 214 may also be any type of executable software code such as a kernel component, an application program, a linked library, an object with methods, or other type of executable software code. The user activity log processor 214 may alternatively be a processing device such as an integrated circuit or logic circuitry that executes instructions represented as microcode, firmware, program code or other executable instructions that may be stored on a computer-readable storage medium. The user activity log processor 214 may be operably coupled to storage 216 on the web page server 212 that may store a user activity log 218 with recorded user activities 222 on URLs 220.

A database server 224 may be operably coupled to one or more web page servers 212 by the network 210. The database server 224 may be any type of computer system or computing device such as computer system 100 of FIG. 1. A database engine 226 may execute on the database server 224 and may include functionality for storing and retrieving data of user activities on properties of a website and financial data for properties of a website. The database engine 226 may be operably coupled to database storage 228 on the database server 224 that may store activities 234 on properties 232 of a website for a user identifier 230 and a monetary value 236 for a user identifier 230. The database storage 228 may also store financial data 238 for properties 240 of a website, including revenue 244 for revenue types 242 and cost 248 for cost types 246.

Those skilled in the art will also appreciate that many of the components of the computer system 100 and the system components for generating a valuation of online users and websites illustrated in FIG. 2 may be implemented in various embodiments within a system-on-a-chip architecture including memory, external interfaces, the operating system, the user activity log processor and the database engine. System-on-a-chip implementations are common for special purpose hand-held devices, such as mobile phones, digital music players, personal digital assistants and the like.

The present invention may support many applications that generate a monetary valuation of online activities. For example, the lifetime value of an online user for a website may be estimated by using the monetary value of the online user on the website for each of multiple time periods. Furthermore, the valuation of a website may be estimated by an application using the monetary values of the online users on the website. The present invention may also be used by an application to improve monetization of online users by identifying segments or cluster of users based on their activity profiles and their monetary values for targeting campaigns to increase revenue from segments of online users. For any of these applications, a monetary value of an online user on the website may be generated by the present invention for the user's online activities on the website.

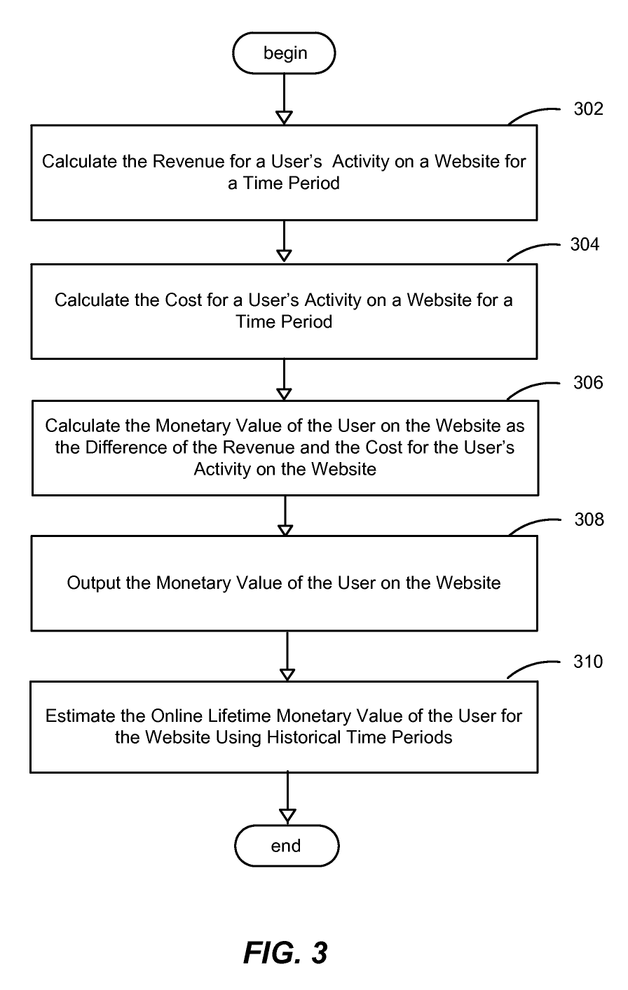

FIG. 3 presents a flowchart for generally representing the steps undertaken in one embodiment for generating a valuation of online users. At step 302, the revenue for a user may be calculated across websites for a time period. In general, the revenue generated by a user may be derived from activities performed by a user on properties of a website. For instance, examples of activities may include viewing an advertisement on an email property for a particular country, clicking on an advertisement for a real estate property, entering a search query on a photo sharing property and clicking a sponsored search link, shopping for a premium service such as a financial service on a website, shopping for a product such as a digital camera, memory card, etc., from an online shopping property, purchasing a subscription to an online bidding property, and so forth.

At step 304, the cost for a user may be calculated across websites for the time period. Each online property may have several cost factors that may be identified and assigned a cost value. For example, data center costs may have identified cost factors such as bandwidth usage costs for serving web pages to user clients, storage costs for data storage used in various services by individual users of the services, amortized employee costs for websites, and so forth.

At step 306, the monetary value of a user may be calculated as the difference of the revenue for a user and the cost for a user. And at step 308, the monetary value of a user may be output, such as storing the monetary value by user identifier in a database. Furthermore, the lifetime monetary value of the user may be estimated for the website at step 310. In an embodiment, the lifetime monetary value of the user may be estimated by an application such as application 208 of FIG. 2 executing on application client 206 based on the monetary values of the user in previous time periods. Any extrapolation model like a linear regression based model may be executed by the application to predict the lifetime monetary value of the user based on the monetary values of the user in previous time periods and the user's retention patterns.

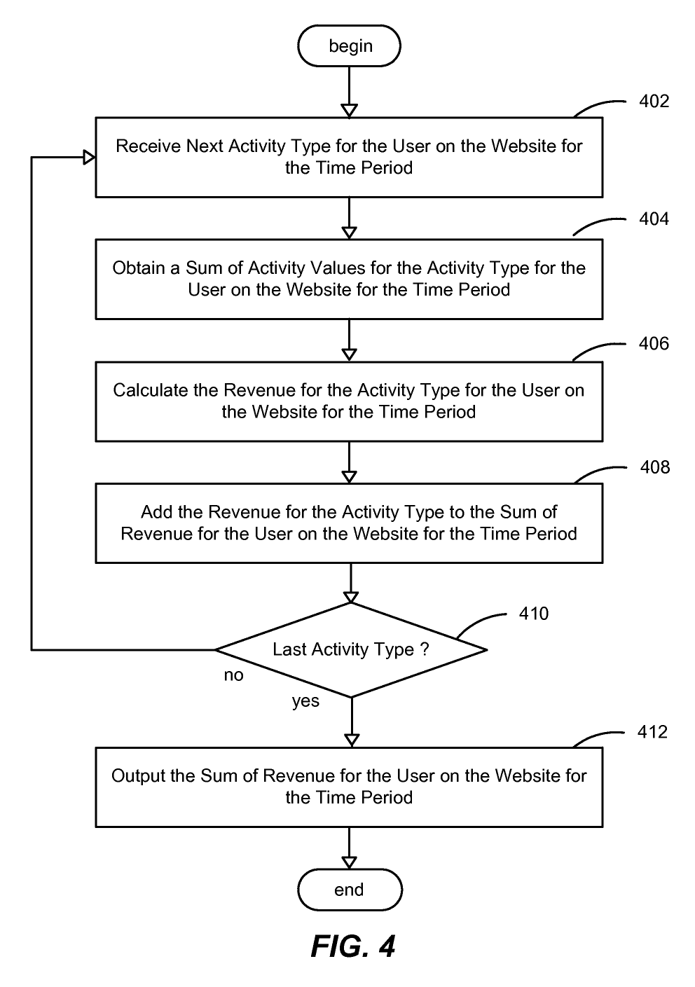

FIG. 4 presents a flowchart for generally representing the steps undertaken in one embodiment for calculating the revenue for activities of a user on a website for a time period. To calculate the revenue for activities of a user on a website, in general, values for types of activities of a user on website may be accumulated and input into a function with values of revenue types associated with activities of users on the website. At step 402, an activity type for an activity of a user on the website may be received for a time period. In an embodiment, the activity type of a user on a website may be retrieved from a data cube, which may be referred to as ActivityCube, with a dimension of user identifiers, a dimension of website property identifiers, and a dimension of activity type identifiers. In particular, a query function, AccessActivityCube(User U, Property P, ActivityType A) may be invoked in an embodiment to return the value on the cell (U, P, A) which may store an aggregate value of the activity identified by the activity type A by the User U on the website property P.

The type of value in each of the cells of the data cube may vary according to the activity type and the value in each of the cells of the data cube depends on the values of each of the three axes. For example, if a user may have four photos on a photo sharing website and may use 1.35 MB of storage space on website servers, then the cell of the data cube corresponding to the dimensions (User ID, PhotoSharing site ID, StorageUtilization) may be assigned the value of 1.35 MB, where the website identifier is PhotoSharing site ID and the activity is StorageUtilization. As another example, if there have been 38 page views for a user, then the cell of the data cube corresponding to the dimensions (User ID, PhotoSharing site ID, PageViews) may be assigned the value of 38, where the website identifier is PhotoSharing site ID and the activity is PageViews. And, if a user may have a monthly premium subscription of $3.25, then the cell of the data cube corresponding to the dimensions (User ID, PhotoSharing ID, SubscriptionAmt) may be assigned the value of $3.25, where the website identifier is PhotoSharing ID and the activity is SubscriptionAmt.

At step 404, a sum of activity values may be obtained for the activity type for the user on the website for the time period. In an embodiment, a function AggregateCol(Dimension1, Dimention2) may be defined on the data cube, ActivityCube, which sums the column corresponding to any two dimensions input as parameters to the function. The sum of activity values may be obtained for the activity type for the user on the website by invoking the function AggregateCol(Activity Type ID, Property ID) for a user on the data cube, where the activity type ID is the identifier for the activity type and the property ID is the identifier for the website.

At step 406, the revenue for the activity type may be calculated for the user on the website for the time period. In an embodiment, a financial data matrix, referred to as FinanceMatrix(Property P, RevenueCostType T), with two dimensions may be accessed to retrieve a revenue value for a revenue type associated with an activity type for a website. The first dimension is a dimension of website property identifiers, and the second dimension is a dimension of revenue and cost type identifiers. The second dimension may thus have an identifier for a revenue type such as advertising click revenue, advertising impression display revenue, premium subscription revenue, and so forth. And the second dimension may also have an identifier for a cost type such as bandwidth usage costs, storage costs, amortized employee operating costs for websites, and so forth. In an embodiment, the revenue may be calculated by multiplying the ratio of the sum of the activity type values for the user on the website to the sum of the activity type values for all the users on the website by the revenue type value for the website, such as AccessActivityCube(U,P,A)/AggregateCol(P,A)*AccessFinanceMatrix(P, RCT). A function, FU_{—}P_{—}RCT(U, P, RCT, ACube, FMatrix), may accordingly be defined for calculating the revenue for activities of a user on a website, where ACube is a given instance of activity data cube ACube, FMatrix is a given instance of financial data matrix FMatrix, P is a given instance of a website property, and RCT is each revenue/cost type. The function may be defined by an analyst to attribute a user's activity to a revenue type for a website property. For example, an analyst may define the function to attribute revenue from a revenue type for a website property to a user for specific activity type based on his/her activities across activity types such as a email property where $1000 revenue may be recorded from subscriptions revenue type for a specified time period. The other activities on an email property may include advertisement views, web page views as part of reading email, advertisement clicks, and registration for premium service subscriptions. In particular, an analyst can define the function that $1000 revenue generated through subscriptions revenue type will be attributed as follows: 30% to Web Page views by the user, 20% to advertisement views by the user, 30% to advertisement clicks by the user, and 20% of the $1000 revenue generated through subscriptions revenue type be attributed to the actual premium services subscription by user. Thus, in various embodiments, a revenue type may be associated with several activity types, and the revenue may be calculated by a function with a functional relationship defined between a revenue type for website and one or more activity types.

Once the revenue for the activity type may be calculated for the user on the website for the time period at step 406, the revenue for activity type may be added to the sum of revenue for the user on the website for the time period at step 408. In an embodiment, a function, Sum(FU_{—}P_{—}RCT(U, P, RCT, ACube, FMatrix), may be defined for summing the revenue for each revenue type for activities of a particular user on a website. At step 410, it may be determined whether there is another activity type to process for calculating revenue for the user on the website. If not, then the sum of revenue for the user on the website for the time period may be output at step 412. Otherwise, processing may continue at step 402 and the next activity type may be received for the user.

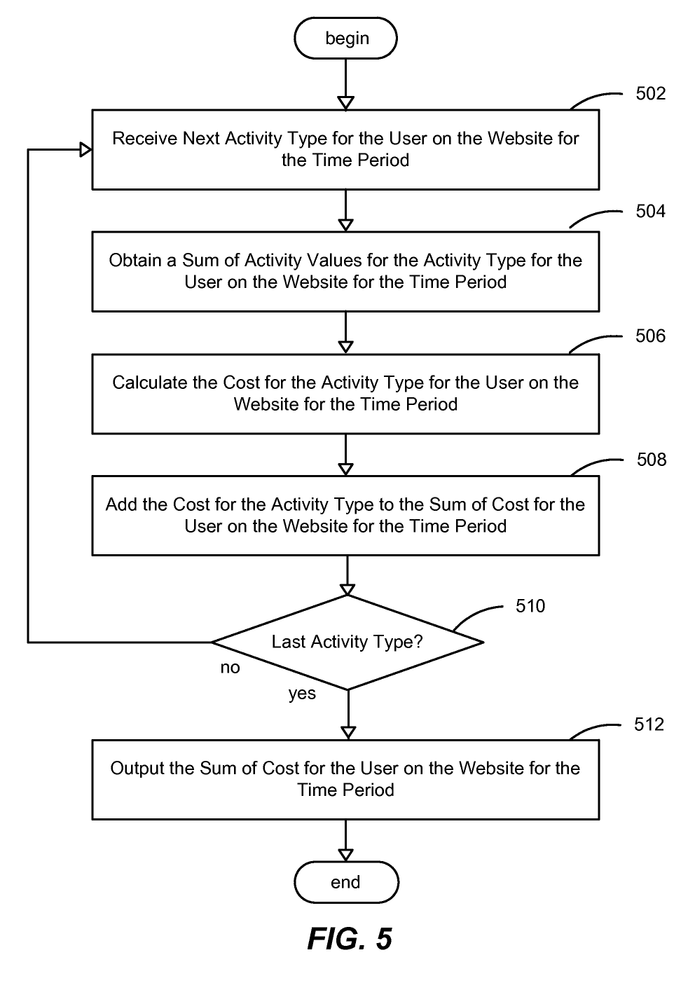

FIG. 5 presents a flowchart for generally representing the steps undertaken in one embodiment for calculating the cost for activities of a user on a website for a time period. To calculate the cost for activities of a user on a website, in general, values for types of activities of a user on website may be accumulated and input into a function with values of cost types associated with activities of users on the website. At step 502, an activity type for an activity of a user on the website may be received for a time period. In an embodiment, the activity type of a user on a website may be retrieved from a data cube, ActivityCube, by invoking the query function, AccessActivityCube(User U, Property P, ActivityType A) to return the value on the cell (U, P, A) which may store a value of the activity identified by the activity type. At step 504, a sum of activity values may be obtained for the activity type for the user on the website for the time period. The sum of activity values may be obtained for the activity type for the user on the website by invoking the function AggregateCol(Activity Type ID, Property ID) for a user on the data cube, where the activity type ID is the identifier for the activity type and the property ID is the identifier for the website.

At step 506, the cost for the activity type may be calculated for the user on the website for the time period. In an embodiment, a financial data matrix, referred to as FinanceMatrix(Property P, RevenueCostType T), with two dimensions may be accessed to retrieve a cost value for a cost type associated with an activity type for a website. The first dimension is a dimension of website property identifiers, and the second dimension is a dimension of revenue and cost type identifiers. The second dimension may thus have an identifier for a cost type such as bandwidth usage costs, storage costs, amortized employee operating costs for websites, and so forth. In an embodiment, the cost may be calculated by multiplying the ratio of the sum of the activity type values for the user on the website to the sum of the activity type values for all the users on the website by the cost type value for the website, such as AccessActivityCube(U,P,A)/AggregateCol(P,A)*AccessFinanceMatrix(P, RCT). The function, FU_{—}P_{—}RCT(U, P, RCT, ACube, FMatrix), defined for calculating the revenue for activities of a user on a website may also be used for calculating the cost for activites of a user on a website, where ACube is a given instance of activity data cube ACube, FMatrix is a given instance of financial data matrix FMatrix, P is a given instance of a website property, and RCT is a cost type.

Once the cost for the activity type may be calculated for the user on the website for the time period at step 506, the cost for activity type may be added to the sum of cost for the user on the website for the time period at step 508. In an embodiment, a function, Sum(FU_{—}P_{—}RCT(U, P, RCT, ACube, FMatrix), may be defined for summing the cost for each cost type for activities of a user on a website. At step 510, it may be determined whether there is another activity type to process for calculating cost for the user on the website. If not, then the sum of cost for the user on the website for the time period may be output at step 512. Otherwise, processing may continue at step 502 and the next activity type may be received for the user.

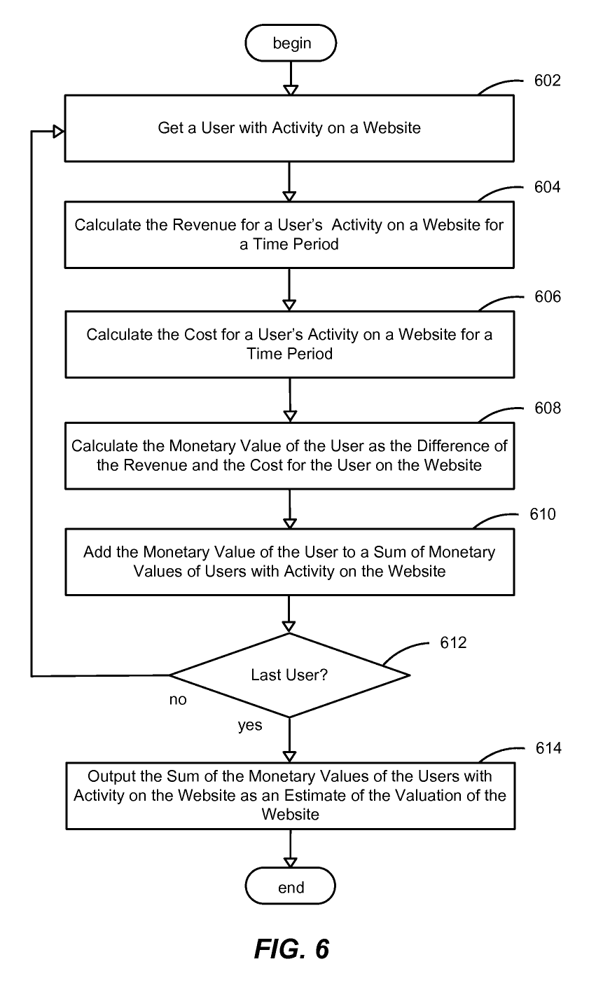

FIG. 6 presents a flowchart for generally representing the steps undertaken in one embodiment for generating a valuation of a website. A user with activity on the website may be obtained at step 602. In an embodiment, a user identifier may be retrieved for a user with activity on the website. At step 604, the revenue for the user's activities on the website may be calculated for a time period. In an embodiment, a function, Sum(FU_{—}P_{—}RCT(U, P, RCT, ACube, FMatrix), may be defined and used for summing the revenue for each revenue type for activities of a user on a website as described above in conjunction with FIG. 4. At step 606, the cost for the user's activities on the website may be calculated for a time period. In an embodiment, a function, Sum(FU_{—}P_{—}RCT(U, P, RCT, ACube, FMatrix), may be defined and used for summing the cost for each cost type for activities of a user on a website as described above in conjunction with FIG. 5.

At step 608, the monetary value of a user may be calculated as the difference of the revenue for a user and the cost for a user. And at step 610, the monetary value of the user may be added to a sum of monetary values of users with activities on the website. It may be determined at step 612 whether there is another user with activity on the website to process for calculating a valuation of a website. If not, then the sum of monetary values of users with activities on the website for the time period may be output at step 614 as an estimate of the valuation of the website. Otherwise, processing may continue at step 602 and the next user with activity on the website may be obtained.

Those skilled in the art will appreciate that a monetary value of a user may also be calculated at the granularity of an activity type for each website. Specific user targeting can then be applied to increase monetization of an activity type for different users on the same website. For example, one user, User 1, may be more interested in premium subscription services on an email website than another user, User 2, who may be more interested in sponsored search on the email website. However, User 1 may be more interested in sponsored search on a financial content website, and User 2 may be more interested in premium subscription services on the financial content website. As a result, different targeting may be applied for User 1 and User 2 when they visit the same website. For instance, when User1 visits the email website, User 1 may be targeted for an offer for new premium services providing additional storage for email, since there is high probability of User 1 signing up for new premium services on the email website. When User 2 visits the email website, User 2 may be targeted for sponsored search advertisements, since there is a high probability of User 2 generating more value in sponsored search activities. But when User 2 visits the financial content website, User 2 may be targeted for an offer for new premium services for the financial content website, since there is high probability of User 2 signing up for new premium services on the financial content website. By taking into consideration the monetary value of activity types of activities by a user on a website, the present invention may be used by an application to improve monetization of online users by identifying segments or cluster of users based on their activity profiles and their monetary values on a website for targeting campaigns to increase revenue from segments of online users.

As can be seen from the foregoing detailed description, the present invention provides an improved system and method for generating a valuation of online users and websites. The revenue for a user's activities on a website may be calculated for a time period, and the cost for the user's activities on the website may be calculated for the time period. In an embodiment, values for each type of activities of a user on website may be accumulated and input into a function with the value of a revenue type or cost type associated with activities of users on the website. The monetary value of an online user for a website may be calculated as the difference of the revenue for a user and the cost for a user on the website. And the monetary value of a user for a website may be output and used by many applications to improve monetization of online users on a website. As a result, the system and method provide significant advantages and benefits needed in contemporary computing, and more particularly in online systems and applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method for valuation of an online user, comprising:
calculating a revenue for a plurality of activities by an online user on a website for a time period;
calculating a cost for the plurality of activities by the online user on the website for the time period;
calculating a monetary value of the online user on the website for the time period as a difference of the revenue for the plurality of activities by the online user on the website for the time period and the cost for the plurality of activities by the online user on the website for the time period; and
outputting the monetary value of the online user on the website for the time period.

2. The method of claim 1 further comprising estimating a lifetime monetary value of the online user on the website using the monetary value of the online user on the website for the time period.

3. The method of claim 2 wherein estimating the lifetime monetary value of the online user on the website using the monetary value of the online user on the website for the time period comprises applying a linear regression model to predict the lifetime monetary value of the user based on a plurality of monetary values of the online user in previous time periods.

4. The method of claim 1 wherein calculating the revenue for the plurality of activities by the online user on the website for the time period comprises receiving a plurality of activity types for the online user on the website for the time period.

5. The method of claim 4 further comprising obtaining a sum of a plurality of activity values for each of the plurality of activity types for the online user on the website for the time period.

6. The method of claim 5 further comprising adding the sum of the plurality of activity values for each of the plurality of activity types to a sum of the revenue for the online user on the website for the time period.

7. The method of claim 1 wherein calculating the cost for the plurality of activities by the online user on the website for the time period comprises receiving a plurality of activity types for the online user on the website for the time period.

8. The method of claim 7 further comprising obtaining a sum of a plurality of activity values for each of the plurality of activity types for the online user on the website for the time period.

9. The method of claim 8 5 further comprising adding the sum of the plurality of activity values for each of the plurality of activity types to a sum of the cost for the online user on the website for the time period.

10. A computer-readable storage medium having computer-executable instructions for performing the method comprising:
calculating a monetary value of an online user on a website for a time period as a difference of the revenue for the plurality of activities by the online user on the website for the time period and the cost for the plurality of activities by the online user on the website for the time period;
adding the monetary value of the online user on the website for the time period to a sum of a plurality of monetary values of users with a plurality of activities on the website for the time period; and
outputting the sum of the plurality of monetary values of users with the plurality of activities on the website for the time period.

11. The method of claim 10 further comprising using the sum of the plurality of monetary values of users with the plurality of activities on the website for the time period to calculate an estimate of a valuation of the website.

12. The method of claim 10 further comprising receiving a plurality of activity types for the online user on the website for the time period.

13. The method of claim 12 further comprising obtaining a sum of a plurality of activity values for each of the plurality of activity types for the online user on the website for the time period.

14. The method of claim 13 further comprising multiplying a value for a revenue type for each of the plurality of activity types with the sum of the plurality of activity values for each of the plurality of activity types.

15. The method of claim 13 further comprising multiplying a value for a cost type for each of the plurality of activity types with the sum of the plurality of activity values for each of the plurality of activity types.

16. The method of claim 14 further comprising adding the product from multiplying a value for the revenue type for each of the plurality of activity types with the sum of the plurality of activity values for each of the plurality of activity types to a sum of the revenue for the online user on the website for the time period.

17. The method of claim 15 further comprising adding the product from multiplying a value for the cost type for each of the plurality of activity types with the sum of the plurality of activity values for each of the plurality of activity types to a sum of the cost for the online user on the website for the time period.

18. A computer system for valuation of an online user, comprising:
means for calculating a revenue for a plurality of activities by an online user on a website for a time period;
means for calculating a cost for the plurality of activities by the online user on the website for the time period;
means for calculating a monetary value of the online user on the website for the time period as a difference of the revenue for the plurality of activities by the online user on the website for the time period and the cost for the plurality of activities by the online user on the website for the time period; and
means for outputting the monetary value of the online user on the website for the time period.

19. The computer system of claim 18 further comprising means for estimating a lifetime monetary value of the online user on the website.

20. The computer system of claim 18 further comprising means for estimating a valuation of the website.
